(19) United States
(12) Patent Application Publication
(10) Pub. No.: US 2009/0251562 A1
(43) Pub. Date: Oct. 8, 2009

(54) IMAGE CAPTURING APPARATUS, IMAGE PROCESSING APPARATUS AND IMAGE PROCESSING METHOD

(75) Inventor: Jun IKEDA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/417,930

(22) Filed: Apr. 3, 2009

(30) Foreign Application Priority Data
Apr. 4, 2008 (JP) P2008-097939

(51) Int. Cl. H04N 9/73; G06K 9/00

(52) U.S. Cl. 348/223.1; 382/167; 348/E09.051

(57) ABSTRACT

An image capturing apparatus includes: a subject image signal generating unit that generates a subject image signal from incident light forming a subject image; a luminance signal and color difference signal generating unit that generates a luminance signal and a color difference signal from the subject image signal; a color difference signal accumulative adding unit that accumulatively adds the color difference signals with lapse of time and outputs an accumulatively added color difference signal; and a signal output unit that outputs the luminance signal generated by the luminance signal and color difference signal generating unit and the accumulatively added color difference signal output by the color difference signal accumulative adding unit.

### BACKGROUND

1. Field of the Invention

The present invention relates to an image capturing apparatus, an image processing apparatus and an image processing method for capturing a subject under dark environments.

2. Description of the Background Art

For typical image pickup, an image capturing apparatus generates a color image based on visible light reflected from a subject. However, if a subject is captured as conventional under poor visible environments, such as in the night, since the visible light reflected from the subject is insufficient, the image becomes so black as not to perceive the subject.

To overcome this problem, there has been proposed a method which allows a subject to be perceived even under dark environments by picking up an image by means of infrared irradiation, as disclosed in JP-2006-148690A. However, this method can generate only a monochrome image other than a color image.

As another example, there is a method of capturing an image by means of long term exposure using a so-called slow shutter. This method can generate a color image by supplementing the amount of light even under dark environments by means of long term exposure.

However, since the slow shutter is opened for a long time, if a subject is moved slightly, a contour of the subject becomes dim, which results in a blurred image with very conspicuous shaking.

Therefore, it is an object of the present invention to provide an image capturing apparatus, an image processing apparatus and an image processing method, which can generate a desired image even under dark environments.

### SUMMARY

According to an aspect of the present invention, there is provided an image capturing apparatus including: a subject image signal generating unit that generates a subject image signal from incident light forming a subject image; a luminance signal and color difference signal generating unit that generates a luminance signal and a color difference signal from the subject image signal; a color difference signal accumulative adding unit that accumulatively adds the color difference signals with lapse of time and outputs an accumulatively added color difference signal; and a signal output unit that outputs the luminance signal generated by the luminance signal and color difference signal generating unit and the accumulatively added color difference signal output by the color difference signal accumulative adding unit.

Accordingly, it is possible to generate a desired image even under dark environments since the color difference signals are added with lapse of time.

### BRIEF DESCRIPTION OF THE DRAWINGS

FIG. 1 is a block diagram showing a door phone according to embodiments of the present invention.

FIG. 2 is a block diagram of an image capturing apparatus shown in FIG. 1.

FIG. 3 shows arrangement of filters of a color separation filter unit of the image capturing apparatus shown in FIG. 2.

FIG. 4 is a graph showing a light transmission characteristic of the color separation filter unit of the image capturing apparatus shown in FIG. 2.

FIG. 5 is a block diagram of a color difference signal correcting unit of the image capturing apparatus shown in FIG. 2.

FIG. 6 shows a state of accumulative addition by the color difference signal correcting unit.

FIG. 7 is a block diagram showing an image capturing apparatus of a door phone according to a second embodiment of the present invention.

FIG. 8 shows arrangement of filters of a color separation filter unit of the image capturing apparatus shown in FIG. 7.

FIG. 9 is a graph showing a transmission characteristic of the color separation filter unit shown in FIG. 8.

FIG. 10 is a block diagram showing a door phone according to a third embodiment of the present invention.

FIG. 11 shows arrangement of filters of a color separation filter unit of the image capturing apparatus shown in FIG. 10.

FIGS. 12A to 12C are graphs showing a transmission characteristic of the color separation filter unit shown in FIG. 11.

### DETAILED DESCRIPTION OF THE PREFERRED EMBODIMENTS

Hereinafter, embodiments of the present invention will be described with reference to the drawings.

### First Embodiment

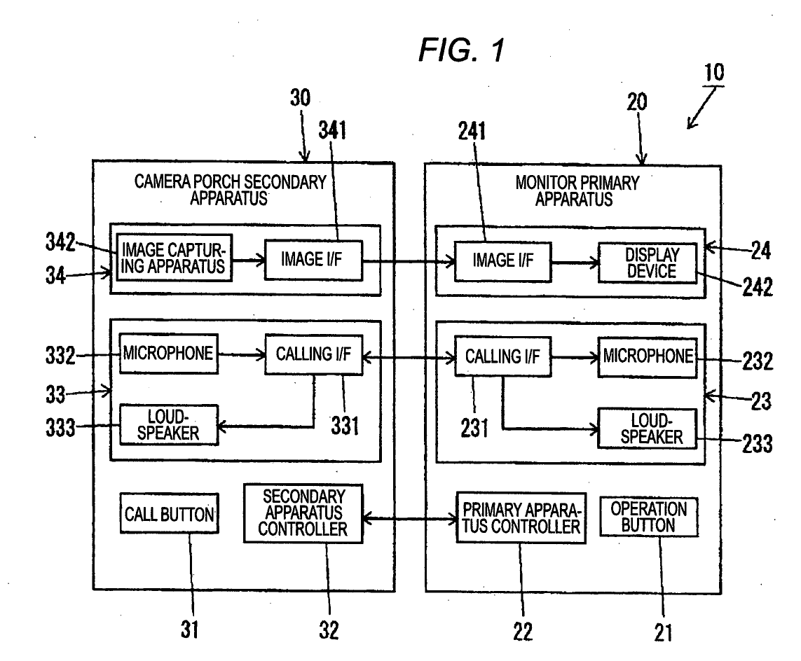

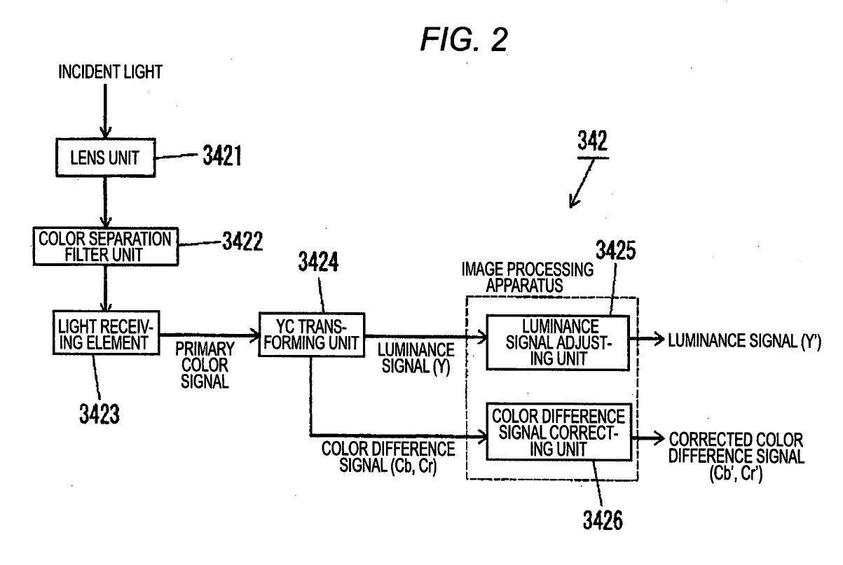

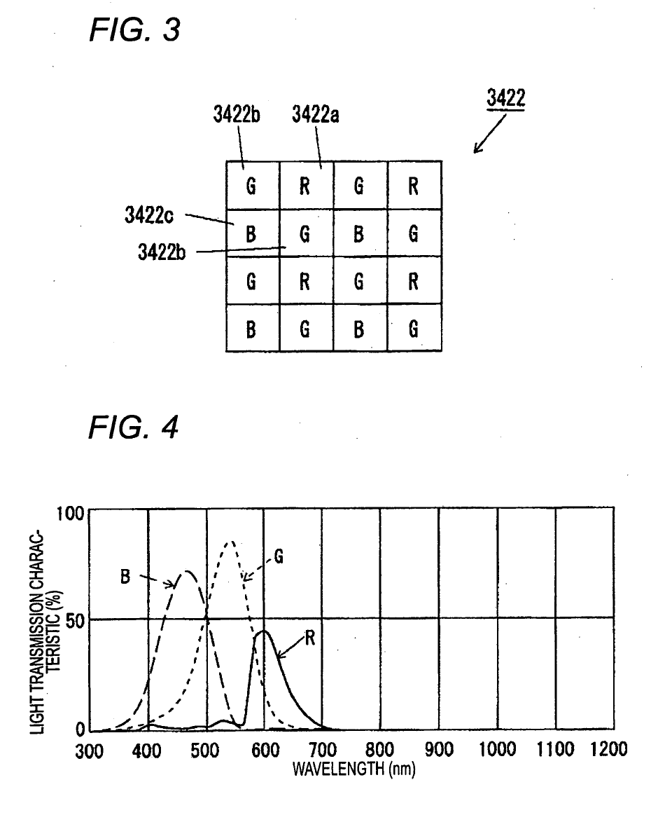

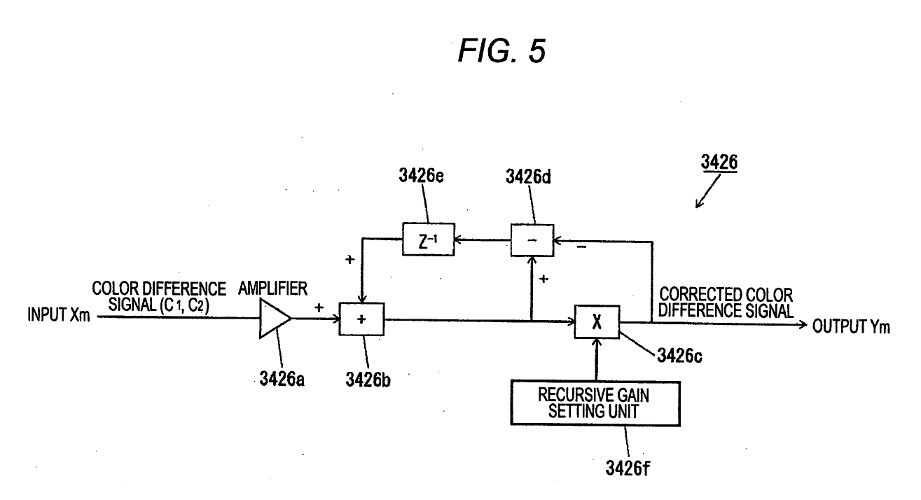

A door phone according to a first embodiment of the present invention will be described with reference to the drawings. FIG. 1 is a block diagram showing a door phone according to an embodiment of the present invention. FIG. 2 is a block diagram of an image capturing apparatus shown in FIG. 1. FIG. 3 shows arrangement of filters of a color separation filter of the image capturing apparatus shown in FIG. 2. FIG. 4 is a graph showing a light transmission characteristic of the color separation filter unit of the image capturing apparatus shown in FIG. 2. FIG. 5 is a block diagram of a color difference signal correcting unit of the image capturing apparatus shown in FIG. 2.

A door phone 10 includes a monitor primary apparatus 20 installed in a living room and a camera porch secondary apparatus 30 installed in a porch.

First, the monitor primary apparatus 20 will be described. The monitor primary apparatus 20 includes an operation button 21, a primary apparatus controller 22, a primary apparatus side calling unit 23 and a display controller 24.

The operation button 21 is a response button used when a resident in a living room is on the phone with a visitor, and is connected to the primary apparatus controller 22. The primary apparatus controller 22 has a function to collectively control the primary apparatus as a whole. The primary apparatus controller 22 has a function to make the display controller 24 operable by a call notification sent from the camera porch secondary apparatus 30 and make the primary apparatus side calling unit 23 operable by pressing down the operation button 21. The primary apparatus controller 22 also has a function to make the primary apparatus side calling unit 23 and the display controller 24 stopped by a signal from the operation button 21 pressed down when the resident ends the call with the visitor.

The primary apparatus side calling unit 23 includes a primary apparatus side calling interface unit 231, a primary apparatus side microphone 232 and a primary apparatus side loudspeaker 233.

The primary apparatus side calling interface unit 231 is to perform an operation of input/output of a voice signal to/from the camera porch secondary apparatus 30. The primary apparatus side microphone 232 outputs a voice of the resident as a voice signal. The primary apparatus side loudspeaker 233 outputs a voice signal from the camera porch secondary apparatus 30 as a voice.

The display controller 24 includes a primary apparatus side image interface unit 241 and a display device 242. The primary apparatus side image interface unit 241 has a function to receive a moving picture signal from the camera porch secondary apparatus 30. The display device 242 has a function to display an image on a liquid crystal display panel based on a color difference signal and a luminance signal which are parts of the moving picture signal from the primary apparatus side image interface unit 241.

Next, the camera porch secondary apparatus 30 will be described. The camera porch secondary apparatus 30 includes a call button 31, a secondary apparatus controller 32, a secondary apparatus side calling unit 33 and an image pickup controller 34.

The call button 31 is a button pressed down by a visitor and sends a press-down signal to the secondary apparatus controller 32 when the call button 31 is pressed down. The secondary apparatus controller 32 is to control the camera porch secondary apparatus 30 as a whole. The secondary apparatus controller 32 sends a call notification to the monitor primary apparatus 20 by the press-down signal from the call button 31 and makes the secondary apparatus side calling unit 33 and the image pickup controller 34 operable. In addition, the secondary apparatus controller 32 has a function to make the secondary apparatus side calling unit 33 and the image pickup controller 34 stopped by a reply end signal from the monitor primary apparatus 20.

The secondary apparatus side calling unit 33 includes a secondary apparatus side calling interface unit 331, a secondary apparatus side microphone 332 and a secondary apparatus side loudspeaker 333. The secondary apparatus side microphone 332 outputs a voice of the visitor as a voice signal. The secondary apparatus side loudspeaker 333 outputs a voice signal from the monitor primary apparatus 20 as a voice. The secondary apparatus side calling interface unit 331 is to perform an operation of input/output of a voice signal to/from the monitor primary apparatus 20.

The image pickup controller 34 includes a secondary apparatus side image interface unit 341 and an image capturing apparatus 342.

The secondary apparatus side image interface unit 341 has a function to send a moving picture signal from the image capturing apparatus 342 to the monitor primary apparatus 20. The image capturing apparatus 342 outputs a luminance signal and a color difference signal produced from an image signal, which is formed by picking up an image of the visitor, to the secondary apparatus side image interface unit 341, as a moving picture signal. The image capturing apparatus 342 will be now described in detail with reference to FIG. 2.

As shown in FIG. 2, the image capturing apparatus 342 includes a lens unit 3421, a color separation filter unit 3422, a light receiving element 3423, a YC transforming unit 3424, a luminance signal adjusting unit 3425 and a color difference signal correcting unit 3426 functioning as an image processing apparatus.

The lens unit 3421 is a single lens or a lens group as a combination of plurality of lenses. The color separation filter unit 3422 is configured such that a plurality of filters, which transmits only light having red component (R), green component (G) and blue component (B) in visible light, is arrayed on the same plane. For example, the color separation filter unit 3422 includes red filters 3422a which transmit only red component (R), green filters 3422b which transmit only green component (G), and blue filters 3422c which transmit only blue component (B), and is configured to have the minimum unit of 2*2 as shown in FIG. 3. In this configuration of color separation filter unit, two green filters 3422b are arranged diagonal to each other, and a red filter 3422a and a blue filter 3422c are arranged diagonal to each other. A light transmission characteristic of the color separation filter unit 3422 is shown in FIG. 4. The light transmission characteristic of the color separation filter unit 3422 is that each filter has only one peak wavelength within visible light although transmission wavelengths of the filters may be more or less overlapped.

The light receiving element 3423 outputs a primary color signal from a pixel corresponding to each filter in the color separation filter unit 3422, with the red component as an R signal (red color signal), the green component as a G signal (green color signal) and the blue component as a B signal (blue color signal).

The YC transforming unit 3424 has a function to transform the RGB signals into a Y signal as a luminance signal (first luminance signal) and a Cb/Cr signal as color difference signals (first color difference signal).

The luminance signal adjusting unit 3425 adjusts a gain of a Y signal from the YC transforming unit 3424 in consideration of a balance with a corrected color difference signal output from the color difference signal correcting unit 3426, and outputs the Y signal with adjusted gain as an adjusted luminance signal (second luminance signal). That is, the luminance signal adjusting unit 3425 adjusts a gain of the Y signal (first luminance signal) according to amplification of a color difference signal by an amplifier 3426a, which will be described later, in the color difference signal correcting unit 3426. Hereinafter, in some cases, the adjusted luminance signal is referred to as a Y′ signal and each of the corrected color difference signal is referred to as a Cb′/Cr′ signal.

The color difference signal correcting unit 3426 accumulatively adds Cb/Cr signals with the lapse of time and outputs a result of the accumulative addition as the corrected color difference signal (second color difference signal). Here, the color difference signal correcting unit 3426 will be described with reference to FIG. 5. FIG. 5 shows an exemplary configuration of the color difference signal correcting unit 3426.

The color difference signal correcting unit 3426 includes an amplifier 3426a, an adder 3426b, a multiplier 3426c, a subtracter 3426d, a delay element 3426e and a recursive gain setting unit 3426f. The adder 3426b, the multiplier 3426c, the subtracter 3426d and the delay element 3426e constitute an infinite impulse response (IIR) filter.

An input of the amplifier 3426a is connected to the YC transforming unit 3424 (see FIG. 2) and amplifies an input Cb/Cr signal. The adder 3426b adds a signal from the amplifier 3426a and a signal from the delay element 3426e. The multiplier 3426c multiplies a signal from the adder 3426b with a gain set in the recursive gain setting unit 3426f. The subtracter 3426d subtracts a signal from the multiplier 3426c from the signal from the adder 3426b. The delay element 3426e has a function to delay a signal from the subtracter 3426d by one frame. An example of the delay element 3426e may include a memory buffer which stores one frame of the Cb/Cr signal thereinto.

The recursive gain setting unit 3426f sets a parameter G with which an output of the adder 3426b is multiplied by means of the multiplier 3426c. This parameter has a value of a range of 0<G<1. Alternatively, if a divider is provided instead of the multiplier 3426c, the same function can be obtained when a value more than 1 is set in the recursive gain setting unit 3426f.

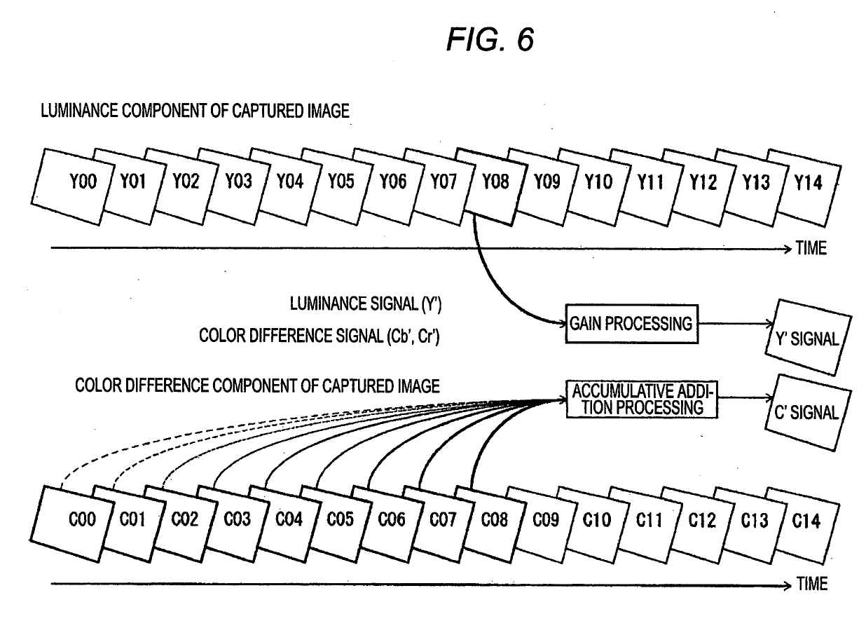

Operation of the door phone configured as above according to the first embodiment of the present invention will be described with reference to the drawings. FIG. 6 shows a state of accumulative addition by the color difference signal correcting unit.

As shown in FIG. 1, when a visitor arrives at a porch, he/she presses down the call button 31. When the secondary apparatus controller 32 is notified that the call button 31 is pressed down, the secondary apparatus controller 32 makes the image pickup controller 34 and the primary apparatus side calling unit 23 operable. In addition, the secondary apparatus controller 32 sends the primary apparatus controller 22 of the monitor primary apparatus 20 a calling notification indicating that the call button 31 is pressed down.

The primary apparatus side calling unit 23 is input with a voice of the visitor by means of the secondary apparatus side microphone 332 and sends the voice to the monitor primary apparatus 20 via the secondary apparatus side calling interface unit 331. The image capturing apparatus 342 sends a captured image of the visitor to the monitor primary apparatus 20 via the secondary apparatus side image interface unit 341.

Here, operation of the image capturing apparatus 342 will be described with reference to FIGS. 2 to 5. As shown in FIG. 2, incident light forming an image of a subject passes the lens unit 3421 and arrives at the color separation filter unit 3422. When the incident light passes the color separation filter unit 3422, the light is separated into RGB color components and RGB signals (primary signals) corresponding to the respective RGB color components are output as an image signal by the light receiving element 3423.

The YC transforming unit 3424 input with the image signal generates a Y signal and a Cb/Cr signal based on the image signal, outputs the Y signal to the luminance signal adjusting unit 3425, and outputs the Cb/Cr signal to the color difference signal correcting unit 3426.

As shown in FIG. 5, in the color difference signal correcting unit 3426, first, the amplifier 3426a amplifies the Cb/Cr signal input thereto. For example, if the amplifier 3426a has an amplification degree of a factor of 10, the Cb/Cr signal generated from the image signal of the visitor in the dark is increased in its magnitude by ten times, including noises. Here, for the purpose of ease understanding, assuming that a level of the input Cb/Cr signal is 1, a level of an output from the amplifier 3426a becomes 10.

Next, an output from the amplifier 3426a is added to a signal delayed by the delay element 3426e, that is, a Cb/Cr signal accumulatively added up to the previous frame, by means of the adder 3426b. The added Cb/Cr signal is multiplied with a value set in the recursive gain setting unit 3426f by means of the multiplier 3426c. Here, it is assumed that a value ½ is set in the recursive gain setting unit 3426f. Then, a Cb/Cr signal corresponding to ½ of the amplified Cb/Cr signal, that is, having a level of 5, is output from the multiplier 3426c and then is input to the subtracter 3426d. In the subtracter 3426d, a signal is generated by subtracting the Cb/Cr signal (½), which was output from the multiplier 3426c, from the Cb/Cr signal before being input to the multiplier 3426c. The generated signal is sent to the delay element 3426e.

The Cb/Cr signal from the subtracter 3426d is delayed by one frame by means of the delay element 3426e and then is added to a Cb/Cr signal of a next frame by means of the adder 3426b. Assuming that a level of the Cb/Cr signal of the next frame is 1, a Cb/Cr signal having the level of 10, which is amplified in the amplifier 3426a, is added to the Cb/Cr signal having a level of 5, which was delayed by one frame by means of the delay element 3426e, by means of the adder 3426b, thereby producing a color difference signal having a level of 15, which is then output to the multiplier 3426c.

Then, a Cb/Cr signal having a level of 7.5 is output from the multiplier 3426c and then a Cb/Cr signal having a level of 7.5 is input from the subtracter 3426d to the delay element 3426e. By repeating this process for a sufficient period of time, Cb/Cr signal are accumulatively added for every frame with the lapse of time and thus a level of a Cb/Cr signal output from the multiplier 3426c (Cb′/Cr′ signal) becomes slowly converged to 10. In other words, although a Cb/Cr signal generated from the image signal of the visitor in the dark is amplified, including randomly generated noises, since the discontinuously or randomly generated noises become faint, without being accumulatively added, by means of the IIR filter composed of the adder 3426b, the multiplier 3426c, the subtracter 3426d and the delay element 3426e, it is possible to amplify the Cb/Cr signal with the noises suppressed. Accordingly, an S/N ratio can be enhanced.

FIG. 5 and the above description may be expressed as the follow equations.

Assuming that an input, an output and a recursive gain of the color difference signal correcting unit 3426 is Xn, Yn and a, respectively (Xn: input signal, Yn: output signal, and a: recursive gain), the following equations may be established:

nth output: Yn=10·{a·Xn+(1−a)·Yn−1}

(n−1)th output: Yn−1=10·{a*Xn−1+(1−a)·Yn−2}

(n−2)th output: Yn−2= . . .

As can be seen from the above equations, a signal before one frame is affected at a ratio of (1-a), a signal before two frames is affected at a ratio of square, i.e., (1-a)², a signal before three frames is affected at a ratio of cubic, i.e., (1-a)³, etc. That is, a signal before more frames is affected at a less ratio.

For example, if the recursive gain a is ½,

Yn=5·Xn+5·Yn−1

In this case, a signal before one frame is reflected in a signal of a current frame at a ratio of ½. In addition, a signal before the previous frame is reflected in a signal of the current frame at a ratio of ¼.

As another example, if the recursive gain a is set to ¼,

Yn=2.5·Xn+7.5*Yn−1

In this case, a signal corresponding to ¼ of the Cb/Cr signal is output from the multiplier 3426c, and a Cb/Cr signal (¾) is generated in the subtracter 3426d by subtracting the Cb/Cr signal (¼), which was output from the multiplier 3426c, from the Cb/Cr signal before being input to the multiplier 3426c. In this case, a signal before one frame is reflected in a signal of a current frame at a ratio of ¾ and a signal before two frames is reflected in a signal of the current frame at a ratio of (¾)²= 9/16. In addition, a signal before the previous frame is reflected in a signal of the current frame at a ratio of 27/64.

Accordingly, since discontinuously or randomly generated noises in a color difference signal become faint whenever the color difference signal is accumulatively added, it is possible to amplify the Cb/Cr signal with the noises suppressed. Accordingly, an S/N ratio can be enhanced.

In this manner, the color difference signal correcting unit 3426 outputs the input Cb/Cr signal as a corrected color difference signal (Cb′/Cr′ signal). In addition, the Y signal from the YC transforming unit 3424 shown in FIG. 2 is amplified with a predetermined amplification degree and is output as a adjusted luminance signal (Y′ signal) by the luminance signal adjusting unit 3425. The luminance signal adjusting unit 3425 adjusts its gain to a balance between the Y signal (first luminance signal) and the corrected color difference signal (second color difference signal).

The Y′ signal and the Cb′/Cr′ signal output from the image capturing apparatus 342 as shown in FIG. 1 are sent as a moving picture signal to the monitor primary apparatus 20 via the secondary apparatus side image interface unit 341.

In the monitor primary apparatus 20, an image is displayed on the liquid crystal display panel provided in the display device 242 based on the Y′ signal and Cb′/Cr′ signal received via the primary apparatus side image interface unit 241.

Since a color difference component of this displayed image can be amplified with a noise suppressed by accumulatively adding the Cb/Cr signal for every frame, as shown in FIG. 6, it is possible to display a color image even under poor visible environments, such as in the night or in the dark.

In addition, differently from a slot shutter with an interval between frames lengthened by lengthening exposure time, since a luminance component forming a contour of a subject uses the Y signal for every frame, although more or less color spread appears in an image due to quick motion of the subject by accumulative addition of the Cb/Cr signal, it is possible to obtain a color image with a clear contour of the subject.

In addition, although the IIR filter is employed as the color difference signal correcting unit 3426 of the image capturing apparatus 342 according to the first embodiment, the color difference signal correcting unit may be formed with memory buffers for storing color difference signals by a predetermined frame and an adder for reading the color difference signals from the memory buffers at once and adding the read color difference signals, for the purpose of accumulative addition of the color difference signals. However, when the IIR filter is employed as the color difference signal correcting unit 3426, since the memory buffer as the delay element 3426e has only to have just one frame, it is preferable that the IIR filter is employed as the color difference signal correcting unit 3426 to accumulatively add the color difference signal.

### Second Embodiment

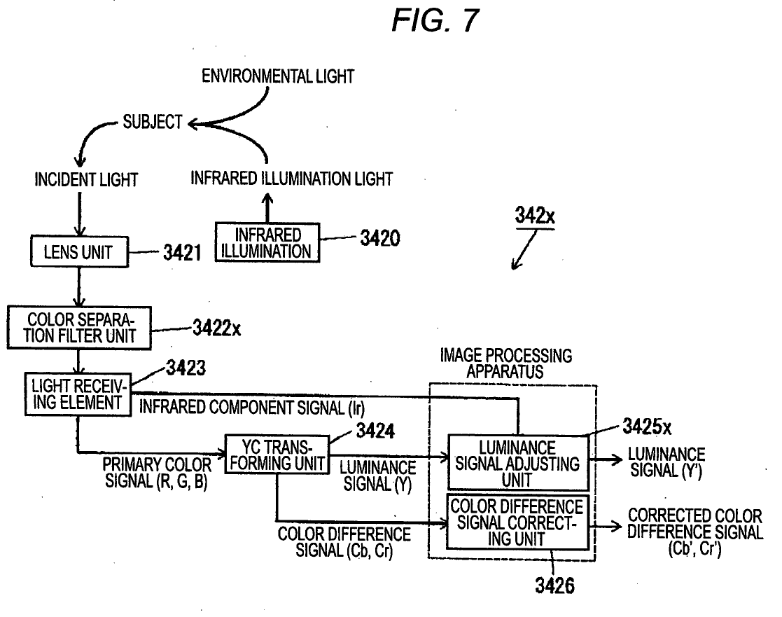

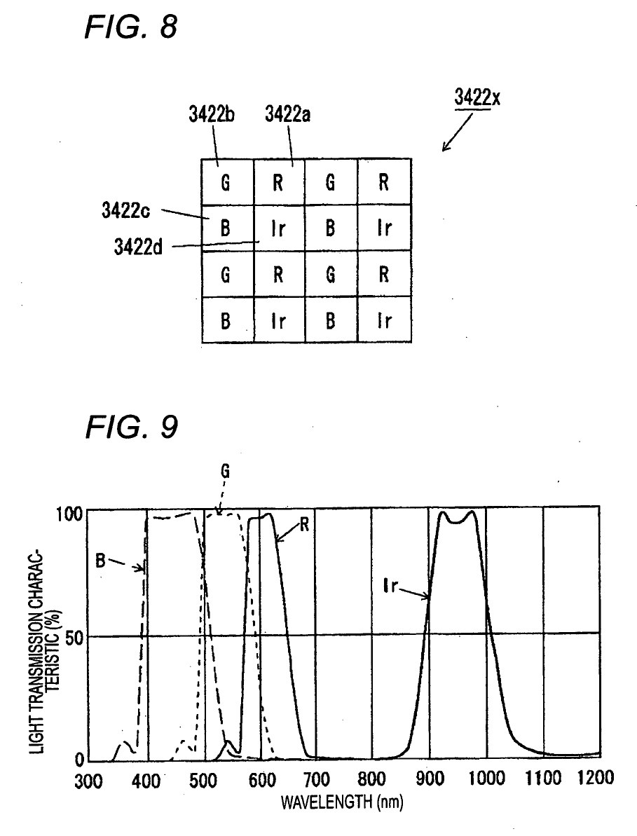

A door phone according to a second embodiment of the present invention will be described with reference to FIGS. 7 to 9. FIG. 7 is a block diagram showing an image capturing apparatus of a door phone according to a second embodiment of the present invention. FIG. 8 shows arrangement of filters of a color separation filter unit of the image capturing apparatus shown in FIG. 7. FIG. 9 is a graph showing a transmission characteristic of the color separation filter unit shown in FIG. 8. In FIG. 7, the same components as FIG. 2 are denoted by the same reference numerals, and explanation of which will be omitted.

As shown in FIG. 7, an image capturing apparatus 342x of the door phone according to the second embodiment is mounted in place of the image capturing apparatus 342 of the camera porch secondary apparatus 30 shown in FIG. 1. The image capturing apparatus 342x according to the second embodiment of the present invention is characterized by using infrared light as a luminance signal by employing a color separation filter unit 3422x which transmits an infrared component in addition the RGB components.

The image capturing apparatus 342x is provided with an infrared illumination 3420 to prevent a visitor as a subject from being threatened. Light from the subject illuminated with this infrared illumination 3420 and ambient environmental light is separated into respective components by the color separation filter unit 3422x provided in front of the light receiving element 3423.

The color separation filter unit 3422x is configured such that a plurality of filters, which transmits only light having red component (R), green component (G) and blue component (B) in visible light and a filter, which transmits only an infrared component (Ir), are arrayed on the same plane. For example, the color separation filter unit 3422x includes red filters 3422a which transmit only red component (R), green filters 3422b which transmit only green component (G), blue filters 3422c which transmit only blue component (B), and infrared filters 3422d which transmit only infrared component (Ir), and is configured to have the minimum unit of 2*2 as shown in FIG. 8. In this configuration of color separation filter unit, the green filter 3422b and the infrared filter 3422d are arranged diagonal to each other, and the red filter 3422a and the blue filter 3422c are arranged diagonal to each other. A light transmission characteristic of the color separation filter unit 3422x is shown in FIG. 9. The light transmission characteristic of the color separation filter unit 3422x is that each filter has only one peak wavelength within visible light although transmission wavelengths of visible light of the filters may be more or less overlapped. The infrared filter 3422d transmits only an infrared region.

A light receiving element 3423 shown in FIG. 7 outputs a primary color signal, with the red component as an R signal (red color signal), the green component as a G signal (green color signal) and the blue component as a B signal (blue color signal), and an Ir signal (infrared signal) with the infrared component from a pixel corresponding to each filter in the color separation filter unit 3422x. The primary color signal is output as an image signal to the YC transforming unit 3424. The YC transforming unit 3424 may have the same function and configuration as that in the first embodiment.

A luminance signal adjusting unit 3425x has a function to combine the Ir signal as the infrared component signal from the light receiving element 3423 and the Y signal generated from the RGB signals and output from the YC transforming unit 3424 and output a result of the combination as an adjusted luminance signal (Y′ signal). Such combination may be achieved by simply adding the Ir signal to the Y signal or adding the Ir signal multiplied with a predetermined integer to the Y signal multiplied with a predetermined integer.

Operation of the image capturing apparatus of the door phone configured as above according to the second embodiment of the present invention will be described with reference to FIG. 7.

Incident light including visible light forming an image of a subject and infrared light passes a lens unit 3421 and arrives at the color separation filter unit 3422x. When the incident light passes the color separation filter unit 3422x, the light is separated into RGB color components and an infrared color component, and RGB signals (primary signals) corresponding to the respective RGB color components are output as an image signal and an Ir signal corresponding to the infrared component is output by the light receiving element 3423.

The YC transforming unit 3424 input with the image signal generates a Y signal and a Cb/Cr signal based on the image signal, outputs the Y signal to the luminance signal adjusting unit 3425x, and outputs the Cb/Cr signal to a color difference signal correcting unit 3426. The color difference signal correcting unit 3426 generates and outputs a Cb′/Cr′ signal which is a corrected color difference signal produced by accumulatively adding the Cb/Cr signal for every frame, as described above.

The luminance signal adjusting unit 3425x combines the infrared signal from the light receiving element 3423 with the Y signal generated from the RGB signals and outputs a result of the combination as a Y′ signal which is an adjusted luminance signal.

In the monitor primary apparatus 20, an image is displayed on the liquid crystal display panel provided in the display device 242 based on a moving picture signal (the Y′ signal and Cb′/Cr′ signal) received via the primary apparatus side image interface unit 241.

Since a color difference component of this displayed image can be amplified with a noise suppressed by accumulatively adding the color difference signal for every frame, it is possible to display a color image even under dark environments. In addition, since only the color difference signal is processed separately from the adjusted luminance signal, a color balance is not collapsed due to variation of luminance. In addition, since a predetermined level of the adjusted luminance signal (Y′) can be not only obtained by simply increasing sensitivity (amplification degree) but also can be increased in compliance with the infrared signal from the infrared illumination 3420, it is possible to clearly capture a contour of a subject in the dark with no noticeable noise. In addition, by using the infrared illumination having a merit of invisibility to persons, a person to be photographed is not threatened.

In addition, although a signal obtained by combining the infrared signal as the adjusted luminance signal with the luminance signal generated from the RGB signals is used in the second embodiment, only the Ir signal may be used as the luminance signal without using the Y signal generated from the RGB signals as the image signal in order to sufficiently secure luminance only with the infrared signal. In this case, since the luminance signal adjusting unit 3425x has no need of signal combination, it is preferable to provide a function to adjust a gain of the Ir signal in consideration of a balance with the corrected color difference signal output from the color difference signal correcting unit 3426.

In addition, although the color image in the second embodiment is a color image obtained when only the infrared signal is used as the luminance signal, and is strictly different from a color image using the luminance signal generated from the RGB signals in the first embodiment, the color image in the second embodiment has a great advantage that an image is colorized by an infrared signal from which only a monochrome image could have conventionally been obtained.

### Third Embodiment

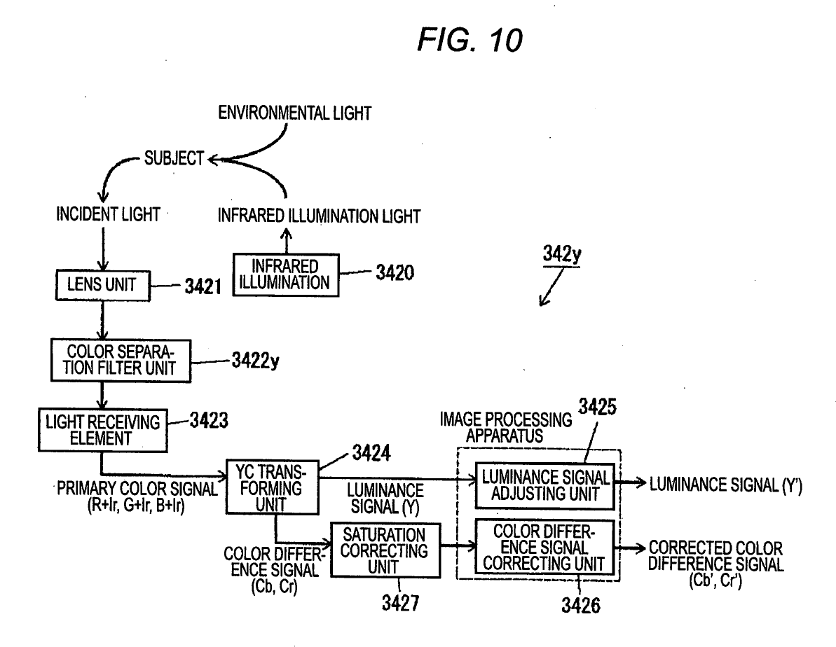

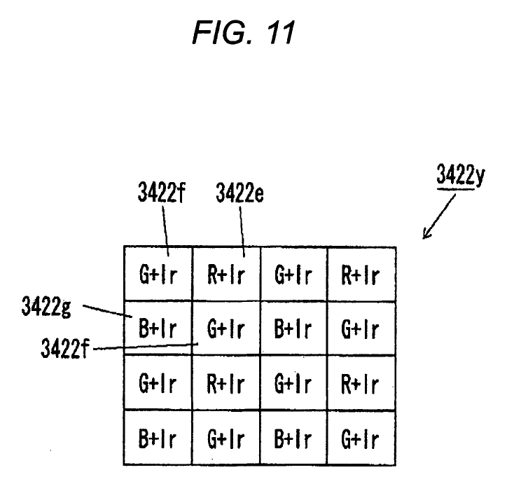

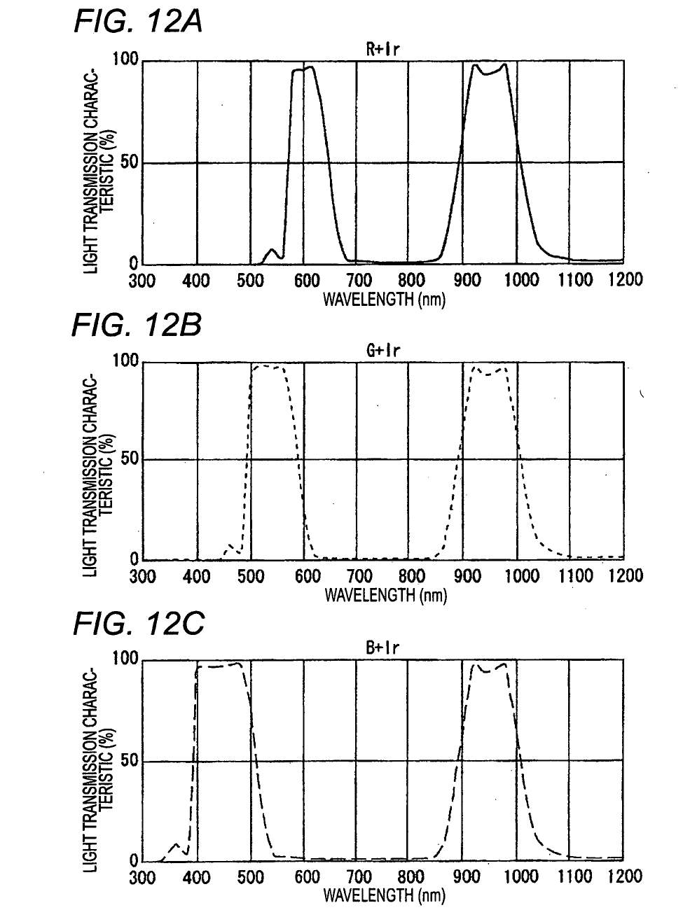

An image capturing apparatus of a door phone according to a third embodiment of the present invention will be described with reference to FIGS. 10 to 12. FIG. 10 is a block diagram showing an image capturing apparatus of a door phone according to a third embodiment of the present invention. FIG. 11 shows arrangement of filters of a color separation filter unit of the image capturing apparatus shown in FIG. 10. FIGS. 12A to 12C are graphs showing a transmission characteristic of the color separation filter unit shown in FIG. 11: FIG. 12A being a graph showing a red component; FIG. 12B being a graph showing a green component; and FIG. 12C being a graph showing a blue component. In FIG. 10, the same components as FIG. 2 or 7 are denoted by the same reference numerals, and explanation of which will be omitted.

As shown in FIG. 10, an image capturing apparatus 342y of the door phone according to the third embodiment is mounted in place of the image capturing apparatus 342 of the camera porch secondary apparatus 30 shown in FIG. 1. The image capturing apparatus 342y is characterized by employing a color separation filter unit 3422y having a two-band transmission characteristic, as a filter unit which transmits RGB components.

The color separation filter unit 3422y provided in the image capturing apparatus 342y has a characteristic of transmitting not only the RGB components but also an infrared component. The color separation filter unit 3422y is configured to have the minimum unit of 2*2 and includes red/infrared filters 3422e which transmit not only a red component (R) but also an infrared component (Ir), green/infrared filters 3422f which transmit not only a green component (G) but also an infrared component (Ir), and blue/infrared filters 3422g which transmit not only a blue component (B) but also an infrared component (Ir), as shown in FIGS. 11 and 12A to 12C. In addition, an infrared transmission characteristic of the color separation filter unit 3422y is set such that infrared image signals are overlapped with respective RGB components at the same level.

In the color separation filter unit 3422y, two green/infrared filters 3422f are arranged diagonal to each other, and the red/infrared filter 3422e and the blue/infrared filter 3422g are arranged diagonal to each other.

When light from a subject transmits the color separation filter unit 3422y having such a two-band transmission characteristic, a light receiving element 3423 can output a signal which is a superimposition of Ir on each RGB component. That is, a superimposition of the Ir component on the color components, with the red/infrared component as an R+Ir signal, with the green/infrared component as a G+Ir signal, and with the blue/infrared component as a B+Ir signal, is output from each pixel corresponding to each filter on the light receiving element 3423. The light receiving element 3423 may have the same function and configuration as those used in the first and second embodiments.

In this manner, since a primary color signal output from the light receiving element 3423 is a mixture signal which is a superimposition of the infrared component on the RGB components, when a Y signal and a Cb/Cr signal are generated by a YC transforming unit 3424 in this way, a color tone of the Cb/Cr signal becomes as faint as the infrared component. Therefore, in the image capturing apparatus 342y according to the third embodiment, a saturation correcting unit 3427 for making correction to make a color tone of a mixture signal deep is provided between the YC transforming unit 3424 and a color difference signal correcting unit 3426.

Now, correction performed by the saturation correcting unit 3427 will be described in detail.

For example, it is assumed that a primary color signal from the light receiving element 3423 when an image is picked up with only somewhat dark environmental light is (R, G, B) and an output signal of the light receiving element 3423 when an image is picked up with only an infrared illumination 3420 is (R_i, G_i, B_i). In addition, it is assumed that a signal as a final target is (n×R, n×G, n×B). That is, the following correction is made to obtain an image signal (n×R, n×G, n×B) which is n times as bright as the primary color signal (R, G, B).

An output of the light receiving element 3423 when an infrared illumination 3420 is used without changing conditions on environmental light, that is, an image signal when the color separation filter unit 3422y is interposed, becomes (R+R_i, G+G_i, B+B_i).

In the YC transforming unit 3424 for transforming the primary color signal (R, G, B) into luminance and color difference signals (Y, Cb, Cr), a transformation equation is expressed as the following Equation 1.

$$( \begin{matrix}Y \\ Cb \\ Cr\end{matrix} ) = ( \begin{matrix}a 11 & a 12 & a 13 \\ a 21 & a 22 & a 23 \\ a 31 & a 32 & a 33\end{matrix} ) \times ( \begin{matrix}R \\ G \\ B\end{matrix} ) \qquad [ Equation 1 ]$$

Next, conditions for approaching (Y_i, Cb_i, Cr_i), which is obtained by multiplying the image signal (R+R_i, G+G_i, B+B_i) with a YC transformation matrix, to (n×Y, n×Cb, n×Cr), which is obtained by multiplying the targeted image signal (n×R, n×G, n×B) with the YC transformation matrix are founded.

$$\begin{matrix}( \begin{matrix}n \times Y \\ n \times Cb \\ n \times Cr\end{matrix} ) = ( \begin{matrix}a 11 & a 12 & a 13 \\ a 21 & a 22 & a 23 \\ a 31 & a 32 & a 33\end{matrix} ) \times ( \begin{matrix}n \times R \\ n \times G \\ n \times B\end{matrix} ) & [ Equation 2 ] \\ ( \begin{matrix}Y\_i \\ Cb\_i \\ Cr\_i\end{matrix} ) = ( \begin{matrix}a 11 & a 12 & a 13 \\ a 21 & a 22 & a 23 \\ a 31 & a 32 & a 33\end{matrix} ) \times ( \begin{matrix}R + R\_i \\ G + G\_i \\ B + B\_i\end{matrix} ) & [ Equation 3 ]\end{matrix}$$

(Regarding Color Difference Component]

The YC transformation matrix shown in the above Equations 2 and 3 has the following properties.

(A) Since a color difference has to be generally always 0 in a white subject, when coefficients are set to make it happen, the following relational Equations 4 and 5 are satisfied.

a21+a22+a23=0 [Equation 4]

a31+a32+a33=0 [Equation 5]

(B) As described above, an infrared transmission characteristic of the color separation filter unit 3422y in the third embodiment is set such that infrared image signals are overlapped with respective RGB components at the same level. That is, levels of the infrared components are made equal, as shown in the following Equation 6.

R_i=G_i=B_i [Equation 6]

According to the above Equations 1 to 6, it is apparent that the infrared components can be excluded from a color difference signal Cb/Cr, and the following Equations 7 and 8 are always established.

Cb_i=Cb [Equation 7]

Cr_i=Cr [Equation 8]

Accordingly, the following Equations 9 and 10 are established.

n×Cb=n×Cb_{—}i [Equation 9]

n×Cr=n×Cr_{—}i [Equation 10]

That is, even in case of image pickup using an infrared illumination, since intensity of infrared light has no effect on color difference components, even for amplification of a factor of n in the saturation correcting unit 3427, it can be seen that only the color difference signal (Cb, Cr) is amplified with a factor of n without the infrared components being amplified and a targeted color difference signal of (n×Cb, n×Cr) is obtained.

(Regarding Luminance Component)

Next, a luminance component will be described.

The coefficients [a11, a12, a13] of the YC transformation matrix shown in the above Equations 2 and 3 generally have the following property.

a11+a12+a13=1.0 [Equation 11]

Where, since the color separation filter unit 3422y has the same infrared transmission characteristics and R_i=G_i=B_i from Equation 6, the following Equation 12 is established.

Y_{—}i=Y+R_{—}i (equally applied to G_i or B_i in place of R_i)

Accordingly, a bright image can be obtained when an infrared component is added to a luminance signal and a level of the luminance signal is increased. By properly setting strength of the infrared illumination 3420 which emits infrared light (in order to establish the relation of n×Y=Y_i) and adjusting an amplification degree n of a Cb/Cr signal in the saturation correcting unit 3427 depending on a degree of luminosity by the infrared illumination 3420, it is possible to obtain a bright image close to a targeted image signal.

In this manner, by using the color separation filter unit 3422y having a desired two-band infrared transmission characteristic and providing the saturation correcting unit 3427 to increase a level of a color difference signal by n times depending on strength of infrared light, a Cb/Cr signal equal to that obtained in case of image pickup under visible light can be obtained. That is, the Cb/Cr signal from the YC transforming unit 3424 has no infrared component, and by amplifying the Cb/Cr signal with a predetermined factor in the saturation correcting unit 3427, it is possible to make correction to raise a level of only the color component and deepen a color tone. Accordingly, even in case of image pickup under infrared light, it is possible to obtain an image having a natural color tone.

In addition, as can be seen from FIG. 11, the RGB components transmitting the color separation filter unit 3422y correspond to four pixels in total, while the RGB components correspond to three pixels in total in the color separation filter unit 3422x employed in the second embodiment. Accordingly, the color separation filter unit 3422y can secure the large amount of transmission of the RGB components. In addition, since the color separation filter unit 3422y has the two-band transmission characteristic, the infrared component is obtained from an area corresponding to four pixels, while only one pixel is assigned to the infrared component in the color separation filter unit 3422x employed in the second embodiment. Accordingly, the color separation filter unit 3422y can obtain the amount of infrared component transmission which is four times as much as the color separation filter unit 3422x employed in the second embodiment in terms of an area ratio.

In this manner, by employing the color separation filter unit 3422y having the two-band transmission characteristic in the image pickup 342y according to the third embodiment, since the total of transmission of light transmitted to the light receiving element 3423 can be increased by adding the infrared component to he respective RGB components, it is possible to achieve enhancement of luminance.

Although several embodiments of the present invention have been described in the above, the present invention is not limited to the disclosed embodiments. For example, although the door phone has been illustrated in the first to third embodiments, the same or similar effects can be obtained even when an image processing program functioning as the color difference signal correcting unit 3426 for accumulatively adding input color difference signals and outputting a result of the addition as a corrected color difference signal is executed by a computer.

In addition, although the luminance signal and the color difference signal are denoted by the Y signal and the Cb/Cr signal, respectively, in accordance with ITU-R BT601 which is a standard for luminance signal and color difference signal specified by International Telecommunication Union (ITU), luminance (Y) and color difference (Pb, Pr) may be employed in accordance with BTA S-001B which is a standard specified by Association of Radio Industries and Businesses (ARIB) in the first to third embodiments.

While the door phone has been illustrated in the first to third embodiments, the present invention is not limited to the door phone but may be suitably applied to programs installed in computers for reproducing or displaying image contents or monitor camera images picked up in digital cameras, video cameras, monitor cameras, in-vehicle cameras, mobile telephones, etc., or in the dark.

Many modifications and variations of the present invention are possible in the light of the above techniques. It is therefore to be understood that within the scope of the invention the invention may be practiced than as specifically described. The present invention application is based upon and claims the benefit of priority of Japanese Patent Application No. 2008-97939 filed on Apr. 4, 2008, the contents of which are incorporated herein by reference in its entirety.

What is claimed is:

1. An image capturing apparatus, comprising:
a subject image signal generating unit that generates a subject image signal from incident light forming a subject image;
a luminance signal and color difference signal generating unit that generates a luminance signal and a color difference signal from the subject image signal; and
a color difference signal accumulative adding unit that accumulatively adds the color difference signals with lapse of time and outputs an accumulatively added color difference signal.

2. The image capturing apparatus according to claim 1, wherein the subject image signal comprises a plurality of color signals, each corresponding to respective one of a plurality of color components.

3. The image capturing apparatus according to claim 2, wherein the subject image signal generating unit includes a filter that separates the incident light into the plurality of color components.

4. The image capturing apparatus according to claim 1, wherein the subject image signal comprises an infrared signal and a plurality of color signals, each corresponding to respective one of a plurality of color components.

5. The image capturing apparatus according to claim 4, wherein the subject image signal generating unit includes a filter that separates the incident light into the plurality of color components and the infrared signal.

6. The image capturing apparatus according to claim 4, wherein the luminance signal and color difference signal generating unit includes:
a luminance signal generating unit that generates a luminance signal from the plurality of color signals; and
a luminance signal combining unit that combines the luminance signal generated by the luminance signal generating unit and the infrared signal.

7. The image capturing apparatus according to claim 1, wherein the subject image signal comprises a plurality of color signals, each signal being a superimposition of an infrared signal on respective one of a plurality of color components.

8. The image capturing apparatus according to claim 7, wherein the subject image signal generating unit includes a filter that separates the incident light into the plurality of color components and transmits the infrared component and respective one of the plurality of color components.

9. The image capturing apparatus according to claim 7, wherein the luminance signal and color difference signal generating unit includes:
a color difference signal generating unit that generates a color difference signal from the plurality of color signals; and
a saturation correcting unit that corrects the color difference signal generated by the color difference signal generating unit.

10. An image capturing apparatus, comprising:
a color signal and infrared signal generating unit that generates a plurality of color signals, each corresponding to respective one of a plurality of color components, and an infrared signal as a luminance signal from incident light forming a subject image; and
a color difference signal generating unit that generates a color difference signal from the plurality of color signals generated by the color signal and infrared signal generating unit.

11. The image capturing apparatus according to claim 10, comprising:
a luminance signal generating unit that generates a luminance signal from the plurality of color signals generated by the color signal and infrared signal generating unit; and
a luminance signal combining unit that combines the luminance signal generated by the luminance signal generating unit and the infrared signal.

12. An image processing apparatus, comprising:
a luminance signal and color difference signal receiving unit that receives a luminance signal and a color difference signal generated from incident light forming a subject image; and
a color difference signal accumulative adding unit that accumulatively adds the color difference signals received by the luminance signal and color difference signal receiving unit with lapse of time and outputs an accumulatively added color difference signal.

13. An image processing method, comprising the steps of:
generating a subject image signal from incident light forming a subject image;
generating a luminance signal and a color difference signal from the generated subject image signal; and
accumulatively adding the generated color difference signals with lapse of time and outputting an accumulatively added color difference signal.

14. The image processing method according to claim 13, wherein the subject image signal comprises a plurality of color signals, each corresponding to respective one of a plurality of color components.

15. The image processing method according to claim 13, wherein the subject image signal comprises a plurality of color signals, each corresponding to respective one of a plurality of color components and an infrared signal.

16. The image processing method according to claim 15, wherein the step of generating a luminance signal and a color difference signal comprises generating a luminance signal from the plurality of color signals and combining the generated luminance signal and the infrared signal.

17. The image processing method according to claim 13, wherein the subject image signal comprises a plurality of color signals, each signal being a superimposition of an infrared component on respective one of a plurality of color components.

18. An image processing method, comprising the steps of:
generating a plurality of color signals, each corresponding to respective one of a plurality of color components, and an infrared signal as a luminance signal from incident light forming a subject image; and
generating a color difference signal from the generated plurality of color signals.

19. The image processing method according to claim 18, comprising the steps of:
generating a luminance signal from the generated plurality of color signals; and
combining the generated luminance signal and the infrared signal.

20. An image processing method, comprising the steps of:
receiving a luminance signal and a color difference signal generated from incident light forming a subject image; and
accumulatively adds the received color difference signals with lapse of time and outputs an accumulatively added color difference signal.
